(19) United States
(12) Patent Application Publication
(10) Pub. No.: US 2002/0163694 A1
(43) Pub. Date: Nov. 7, 2002

(54) Apparatus for optical communications

(75) Inventors: Robert Joseph Mears, Cambridge (GB); Adam David Cohen, Nepean (CA); Stephen Thomas Warr, Ipswich (GB); Michael Charles Parker, Sutton (GB)

Correspondence Address: NIXON & VANDERHYE P.C., 8th Floor, 1100 North Glebe Road, Arlington, VA, 22201-4714, US

(73) Assignee: Cambridge University Technical Services Limited

(21) Appl. No.: 10/134,533

(22) Filed: Apr. 30, 2002

Related U.S. Application Data
(63) Continuation of application No. 09/245,217, filed on Feb. 5, 1999, now abandoned.
Application No. 09/245,217 is a 371 of international application No. PCT/GB97/02131, filed on Aug. 7, 1997.

(30) Foreign Application Priority Data
Aug. 7, 1996 (GB) 9616598.0

(51) Int. Cl. H04J 14/02

(52) U.S. Cl. 359/130

(57) ABSTRACT

A holographic filter for an optical communication system is configurable to provide signal power equalisation for a number of optical signals or signal channels in a wavelength division multiplexed system.

This invention relates to apparatus for optical communications and, in particular, to spectral equalisers for use with optical fibre amplifiers.

Erbium-doped fibre amplifiers (EDFA) are now well established for telecommunications. To maintain an acceptable spectral bandwidth when many amplifiers are concatenated, the need for passive spectral equalisation has long been recognised. However as wavelength division multiplexed (WDM) optical transmission systems begin to be deployed commercially, the need for active management of spectral gain is increasingly important, since individual channel powers may vary over time and the gain spectrum also varies with dynamic input load. One such active technique employing acousto-optic tunable filters (AOTF) was recently reported by S. H. Huang, X. Y. Zou, A. E. Willner, Z. Bao, and D. A. Smith, “Experimental demonstration of active equalisation and ASE suppression of three 2-5-Gbit/s WDM-network channels over 2500 km using AOTF as transmission filters”, Conference on Lasers and Electro-optics, Paper CMA4, 1996. However, the underlying technology is expensive and requires additional optical components in parallel to attain polarisation insensitivity. The present invention relates to a technique for active management of the spectral gain, based on a polarisation-insensitive diffractive ferroelectric liquid crystal (FLC) in-line filter. The technique is scaleable to tens of channels and is potentially low-cost in volume production.

According to the present invention there is provided a spectral equaliser for an optical communication system comprising a number of optical inputs, a number of optical outputs, and a reconfigurable holographic filter arranged in an optical path between the optical inputs and the optical outputs, wherein the reconfigurable holographic filter is configurable to provide signal power equalisation for a number of optical signals or signal channels of predetermined different wavelengths.

There is also provided a reconfigurable holographic filter in combination with processing means storing data on a number of predetermined holograms for configuring the holographic filter, at least one of said holograms being arranged to provide signal power equalisation for a number of optical signals or signal channels of predetermined different wavelengths.

The invention will now be particularly described by way of example, with reference to the accompanying drawings, in which

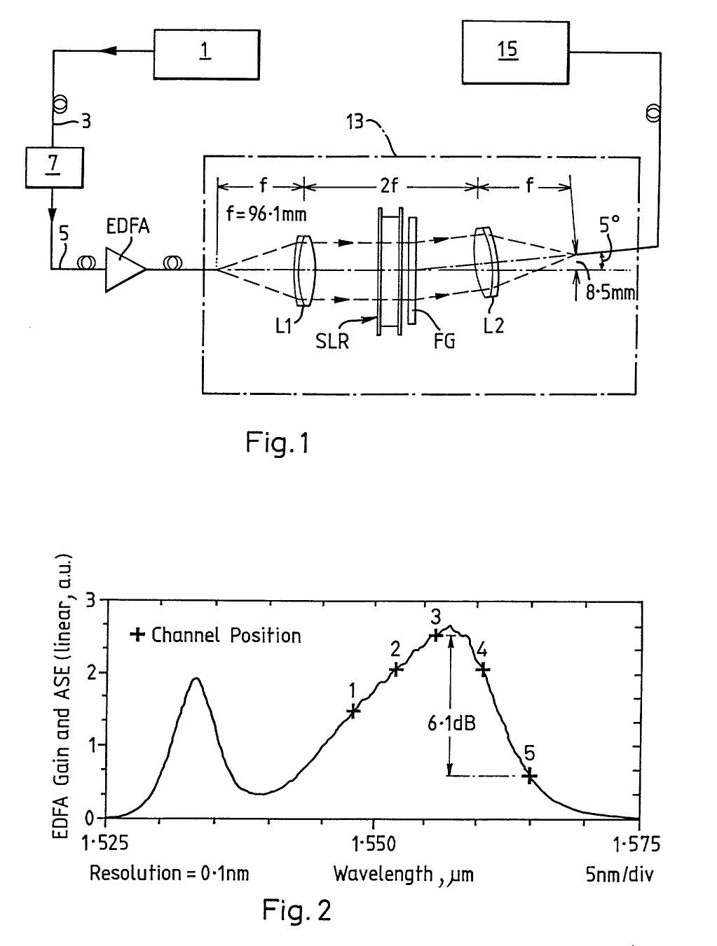

FIG. 1 is an experimental configuration of apparatus in accordance with a specific embodiment of the invention

FIG. 2 is a graph showing characteristics of an Erbium-doped, fibre amplifier

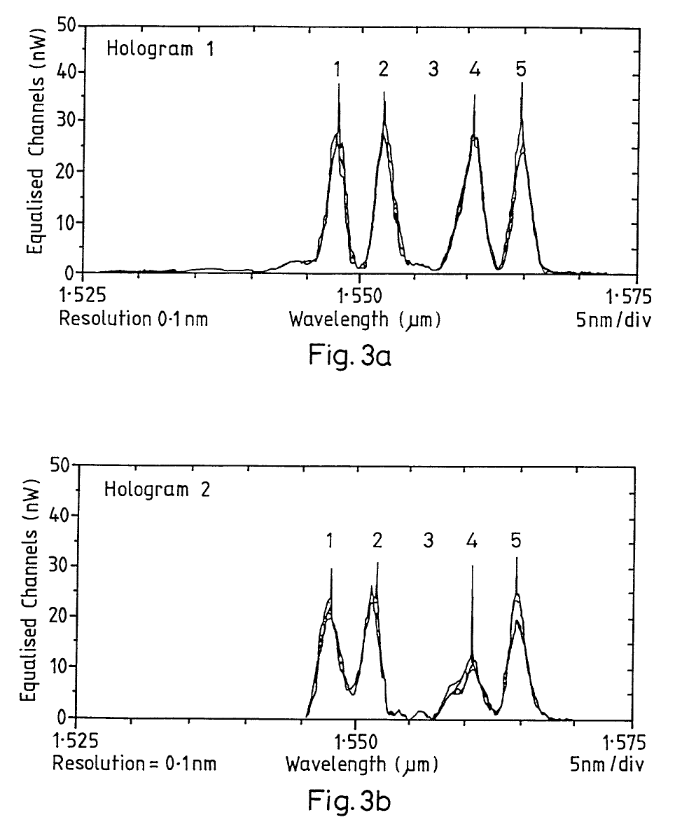

FIGS. 3a and 3b are spectra for two illustrative holograms;

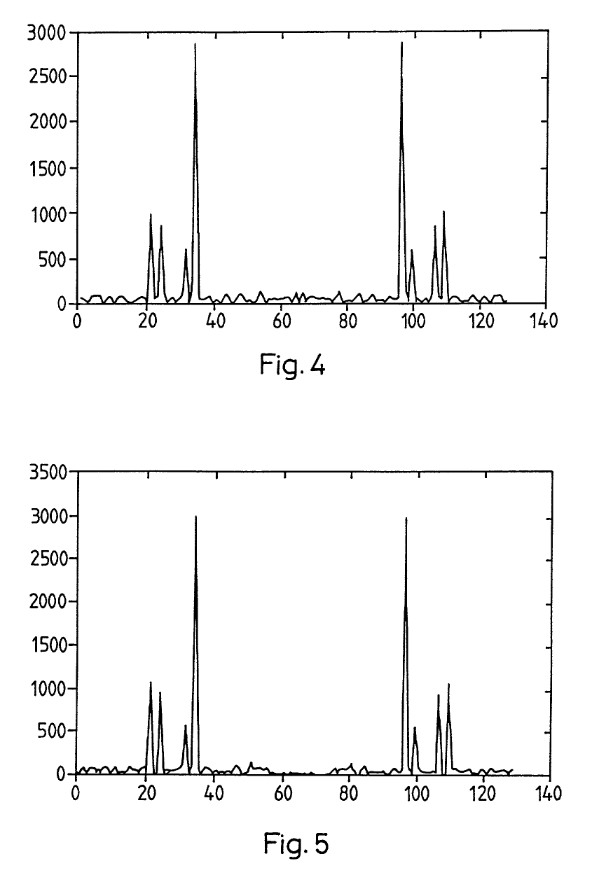

FIGS. 4 and 5 are Fourier transforms of the holograms exemplified in FIGS. 3a and 3b, and

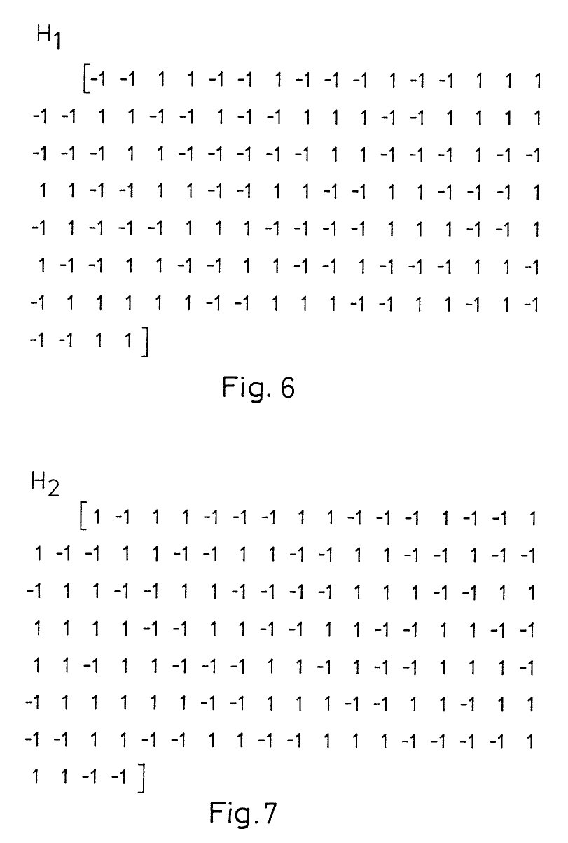

FIGS. 6 and 7 are diagrammatic representations of the holograms.

An experimental configuration, employing single-moded fibre throughout, is shown in FIG. 1. It comprises a tunable laser 1 coupled by a single-mode fibre 3, 5 and a variable attenuator 7 to and erbium-doped fibre amplifier EDFA. The amplifier is connected by way of monomode fibres 9, 11 and an equalising filter 13 an optical spectrum analyser 15.

The equalising filter 13 includes a pair of lenses L1, L2, a transmissive 128×128 matrix reconfigurable holographic filter SLM of pitch D×165 μm and a transmissive fixed grating FG with line pair width d=18 μm. It is designed to provide spectral equalisation and system management over 5 channels spaced by approximately 4 nm as shown in FIG. 2.

In a real wavelength diision multiplexing system, input channel power will vary owing to:

(i) non-uniform gain profiles of the optical amplifiers (e.g. 6.1 dB for the EDFA shown in FIG. 2);

(ii) wavelength dependence of passive optical components; and,

(iii) potential variation in injection losses and signal path losses (e.g. spanning drop and insert nodes in a wavelength routed network.)

In this experimental configuration, input channel variation is simulated by the variable output power tunable diode laser 1. It would be desirable to input all signal. channels simultaneously, but this was not possible with the equipment available. Low signal powers are used to obtain maximum differential gain available from the EDFA, hence overcoming the present high loss of the filter and producing a net gain. The spectral equaliser comprises a reconfigurable holographic filter of the type described in the paper by M. C. Parker and R. J. Mears, “Digitally tunable wavelength filter and laser”. Photonics Technology Letters, 8 (8), 1996, and an EDFA to compensate for the filter losses. The holographic filter comprises a FLC pixellated spatial light modulator (SLM) displaying dynamic holograms, in conjunction with a fixed binary-phase high spatial frequency grating, both within a 4f free-space lensing system (see FIG. 1). The filter passband for each channel has a FWHM of just under 2 nm. The holograms are designed to compensate both for the input channel power variation and the spectral dependence of the EDFA gain, so that uniform output channel powers are achieved. As shown, it is also possible to drop a particular channel, such as that at 1556.1 nm, which is desirable for noise suppression when that channel is temporarily unused. In the figures, the active reconfigurable nature of the equaliser is demonstrated by a variation of both the input power and wavelength of the signal on channel 4, to simulate the signal on that channel coming from a different, source, in the network. Two different holograms were designed to compensate for these changes, and to equalise the signal on channel 4 to the same level as the other three signals. The optical spectrum analyser records the results.

The holograms required to compensate a set of input channel variations and conditions, such as change of use of channels for network restoration), are pre-calculated. The download time here is 5 ms, but with an improved interface it is reasonable to expect reconfiguration in 20 μs.

The equation relating the filter wavelength associated with a hologram spatial period is given approximately by:

$$λ \approx \frac{x}{f ( \frac{n}{ND} + \frac{1}{d} )} \qquad ( 1 )$$

where λ is the filter wavelength, x=8.5 mm is the distance of the output fibre from the optical axis, f=96.1 mm is the focal length, N=128 is the number of pixels in the spatial light modulator, D=165 μm is the spatial light modulator pixel pitch, d=18 μm is the period of the fixed grating. The value n is an integer between 0 and 64. The factor n/ND represents one of the spatial frequencies of the displayed hologram which dictate the wavelengths to be filtered. In contrast to the case in which only a single wavelength is filtered, requiring a single result for n and subsequent hologram design, the above equation has been solved for 5 separate wavelengths, yielding 5 values of n to be fed into a computer-based design process to produce a hologram of mixed spatial frequency. The hologram generation algorithm makes use of simulated annealing, which is modified to control the transmission amplitude of the hologram at multiple wavelengths.

The resulting Fourier transforms (modulus squared) of holograms are shown graphically in FIGS. 4 and 5. It is apparent from the Fourier transforms of these holograms, which are representations of the spectral transmissions, that 4 positions (or wavelengths) are preferentially transmitted by varying degrees. Equation (1) above is simply used to determine the positions of the ‘spots’ in the target function, which is then fed into a simulated annealing algorithm. The algorithm generates a hologram, whose Fourier transform matches the target function as closely as possible.

In the examples, a hologram is generated which equalises the wavelengths at 1548, 1552, 1560 and 1564 nm. For f=96.1 mm, x=8.5 mm, N=128, D=18 μm, the corresponding values for n are 33, 30, 23, 20, where only integer values of n are allowed for this particular hologram generation algorithm.

This means that the target function is a 1×64 matrix of zeros, except that at the positions 20, 23, 30 and 13 of the matrix, there are values, corresponding to the design amplitudes of the holographic transmission spectrum. In this case, the corresponding design amplitudes at these positions were 1.31, 1.22, 1, 2.17 respectively. The resulting two holograms are shown in FIGS. 6 and 7, respectively.

Initial design amplitudes for the holographic transmission spectrum are determined by inverting the ratios of the EDFA amplified spontaneous emission (ASE) levels at the channel wavelengths (see FIG. 2). These design parameters yield holograms with less than ideal channel equalisation due to system non-uniformities. The resulting systematic errors observed in the output spectrum were measured and corrected design parameters fed back to the algorithm. Hologram design would be significantly improved by an in-situ feedback loop.

The equalised spectra for the two different holograms are shown in FIG. 3. For the first case (see FIG. 3a), the unequalled input signals have a 2.0 dB range of powers, which is reduced to less than 0.3 dB after equalisation. For the second case, the input signal powers have a range of 8.5 dB which is reduced to 0.3 dB after equation. Tables 1, and 2 show the input and output powers for the 5 channels, using the 2 holograms respectively to equalise the 4 signals dynamically. The unused channel 3 is suppressed by greater than 13.5 dB in both cases. The large EDFA ASE present around the wavelength 1.533 μm is also successfully suppressed by at least 13.5 dB. The individual channel isolation varies from 6.7 dB to as high as 23 dB.

TABLE 1

| | Wavelength | Input Power | Output Power |
|---|---|---|---|
| Channel | (nm) | (dBm) | (dBm) |
| 1 | 1547.6 | −45.6 | −44.4 |
| 2 | 1551.8 | −46.3 | −44.5 |
| 3 | 1556.1 | no signal | not applicable |
| 4 | 1560.4 | −46.3 | −44.6 |
| 5 | 1564.4 | −47.6 | −44.3 |

TABLE 2

| | Wavelength | Input Power | Output Power |
|---|---|---|---|
| Channel | (nm) | (dBm) | (dBm) |
| 1 | 1547.6 | −45.6 | −45.4 |
| 2 | 1551.8 | −46.3 | −45.1 |
| 3 | 1556.1 | no signal | not applicable |
| 4 | 1560.8 | −39.1 | −45.3 |
| 5 | 1564.4 | −47.6 | −45.0 |

1. A spectral equaliser for an optical communication system comprising a number of optical inputs, a number of optical outputs, and a reconfigurable holographic filter arranged in an optical path between the optical inputs and the optical outputs, characterised in that the reconfigurable holographic filter is configurable to provide signal power equalisation for a number of optical signals or signal channels of predetermined different wavelengths.

2. A spectral equaliser according to, claim 1, characterised in that at least one optical signal receivable at the reconfigurable holographic filter is a multiplexed optical signal comprising two or more channels.

3. A spectral equaliser according to claim 1 or 2, characterised in that the reconfigurable holographic filter is configurable to drop one or more optical signals or individual channels within a multiplexed optical signal.

4. A spectral equaliser according to any preceding claim, comprising two or more optical inputs, characterised in that the reconfigurable holographic filter may be configured to transmit signals from at least two different optical inputs an optical output.

5. A spectral equaliser according to any preceding claim, comprising a plurality of optical outputs, characterised in that the reconfigurable holographic filter is configurable to broadcast one or more optical signals or signal channels to two or more of the optical outputs.

6. A spectral equaliser according to any preceding claim, characterised in that the reconfigurable holographic filter comprises a dynamic holographic diffraction element in combination with a fixed diffraction grating or hologram.

7. A spectral equaliser according to any preceding claim, characterised in that it comprises processing means storing a number of predetermined holograms.

8. A spectral equaliser according to any preceding claim, characterised in that it comprises processing means for dynamically determining holograms for the reconfigurable holographic filter to achieve signal power equalisation.

9. A spectral equaliser according to any preceding claim, characterised in that it further comprising an optical amplifier.

10. A spectral equaliser according to claim 9, characterised in that the optical amplifier is an erbium-doped fibre amplifier.

11. A spectral equaliser according to any preceding claim, characterised in that the holographic filter is configurable to suppress amplified spontaneous emissions.

12. A communication system comprising a spectral equaliser in accordance with any preceding claim.

13. An optical switch comprising a spectral equaliser in accordance with any of claims 1 to 14.

14. A reconfigurable holographic filter in combination with processing means storing data on a number of predetermined holograms for configuring the holographic filter, at least one of said holograms being arranged to provide signal power equalisation for a number of optical signals or signal channels of predetermined different wavelengths.
